(19) United States
(12) Patent Application Publication
(10) Pub. No.: US 2012/0328081 A1
(43) Pub. Date: Dec. 27, 2012

(54) X-RAY TUBE

(75) Inventor: Gerhard Fenkart, Zurich (CH)

(73) Assignee: MICROTEC S.R.L., 39042 Bressanone (Bolzano) (IT)

(21) Appl. No.: 13/576,593

(22) PCT Filed: Jan. 31, 2011
(86) PCT No.: PCT/IB2011/050411

§ 371 Date: Aug. 22, 2012

(30) Foreign Application Priority Data
Feb. 2, 2010 (IT) VR2010A000016
Jan. 31, 2011 (WO) PCTIB2011/050411

(51) Int. Cl. H01J 35/10

(52) U.S. Cl. 378/141

(57) ABSTRACT

An X-ray tube comprises a containment element (2) in which a cathode (4) and an anode (5) are mounted. The anode (5) comprises a first main face (6) which is substantially facing towards the cathode (4) and a second main face (7) which is facing the opposite way to the first face (6). There are also cooling means (8) applied to the second main face (7) of the anode (5) and filter means (10) for filtering, based on respective wavelengths, the X-rays emitted by the anode (5). The cooling means (8) and the filter means (10) both consist of a heat conductor element (9) which is thermally coupled with the second face (7) of the anode (5) and which is equipped with a plurality of inner micro-channels in which, in practice, a pressurised coolant liquid can flow with a turbulent motion. The containment element also comprises an X-ray emission section (3) positioned in such a way that, in practice, it receives the X-rays emitted from the second main face (7) of the anode (5) after they have passed through the filter means (10).

This invention relates to an X-ray tube for the production of X-rays, and in particular to an X-ray tube able to generate X-rays with relatively high intensity. This invention is aimed in particular at the production of X-ray tubes for use in plants which use X-rays to examine timber. Hereinafter reference is generally made to that sector. However, it shall be understood that this invention may without distinction be applied in any other sector and for any other purpose.

Since they were invented, more than a century ago, X-ray tubes have usually consisted of a vacuum container (normally a glass bulb), housing a cathode (negative pole) and an anode (positive pole) between which, in practice, a relatively high direct current voltage is applied (even several kV).

The anode is positioned at a predetermined distance from the cathode and consists of a heavy disk made of metal (such as tungsten, molybdenum or rhodium) able to emit X-rays if struck by electrons travelling with a predetermined kinetic energy as is explained in more detail below. The disk is positioned obliquely, in the sense that its main face facing towards the cathode is at an angle to the plane perpendicular to the direction linking the cathode and the anode.

In turn, the cathode usually consists of a heated spiral which emits electrons due to a thermionic effect. Once emitted, the electrons are accelerated by the difference in potential existing between the anode and the cathode and then strike the metal disk. At the moment of impact a small part of their kinetic energy is transformed into X-rays according to a known process.

The X-rays generated in this way, by themselves would propagate in all directions.

However, the shape of the anode (a flat disk) means that most of the X-rays existing it propagate in a direction substantially perpendicular to the two faces of the disk. In particular, most of the rays propagate by exiting the opposite face of the disk to that which is facing the cathode (forward rays), whilst a significantly smaller part exits the latter (backward rays).

Moreover, since, during operation, the anode is subject to significant heating, in industrial applications it has to be cooled. At present that is normally done by applying cooling means to the opposite face of the anode to that facing the cathode. The cooling means comprise a box-shaped metal element (usually made of steel) which is in thermal contact with the anode and in which a coolant liquid such as water flows. However, to guarantee correct heat dissipation, the dimensions and structure of the cooling means are such that practically all of the forward rays are absorbed by the box-shaped element or by the cooling water. Consequently, in prior art industrial X-ray tubes, the only rays usable are the backward rays. This is why the anode is positioned at an angle. Indeed, only in this way is it possible to direct the X-rays towards the outside of the tube without dissipating them in the cooling means and without striking the cathode.

However, when the electrons strike the anode rays are generated which cover a wide range of different wavelengths (the actual range depends on the type of metal used to make the anode and the operating voltage, that is to say, the speed of the electrons at the moment of impact).

However, at industrial level only some of the wavelengths are actually useful. For example, to examine timber, any rays with a lower frequency would not only be of no interest because unable to pass through wood, but must be avoided because they could saturate the detection sensor in the absence of wood.

For that purpose, X-ray tubes currently on sale are fitted with a filter which intercepts the backward rays before they can get out. The filter consists of a metal plate (for example made of beryllium or copper) which is just a few millimetres thick and can absorb the wavelengths, of the X-rays emitted by the tube, which are not useful for the relative application.

What is described above represents the aspects shared by all prior art solutions. However, it is important to consider that the X-ray tubes currently on the market may also have both electron flow confinement and concentration means, and X-ray confinement means. There are also prior art tubes with a rotating anode, which are designed to continuously vary the point of impact of the electrons on the anode. In any case, this invention may be applied, with the appropriate adjustments, to any X-ray tube.

In light of the above, it seems clear that the main problem of prior art X-ray tubes is that of having low output. Only a small part of the X-rays produced are available for the relative uses.

Consequently, in sectors which require high output (such as the X-ray examination of logs), normal commercial X-ray tubes are unsuitable and special extremely high output tubes with equally high costs must be used.

In this situation the technical purpose which forms the basis of this invention is to provide an X-ray tube which overcomes the above-mentioned disadvantages.

In particular, the technical purpose of this invention is to provide an X-ray tube which, the operating parameters being equal, can supply X-rays with an intensity significantly greater than conventional X-ray tubes.

It is also the technical purpose of this invention to provide an X-ray tube which, the output being equal, is less expensive than the conventional tubes.

The technical purpose specified and the aims indicated are substantially achieved by an X-ray tube made as described in the appended claims.

Further features and the advantages of this invention are more apparent in the detailed description, with reference to the accompanying drawings which illustrate several preferred, non-limiting embodiments of an X-ray tube, in which:

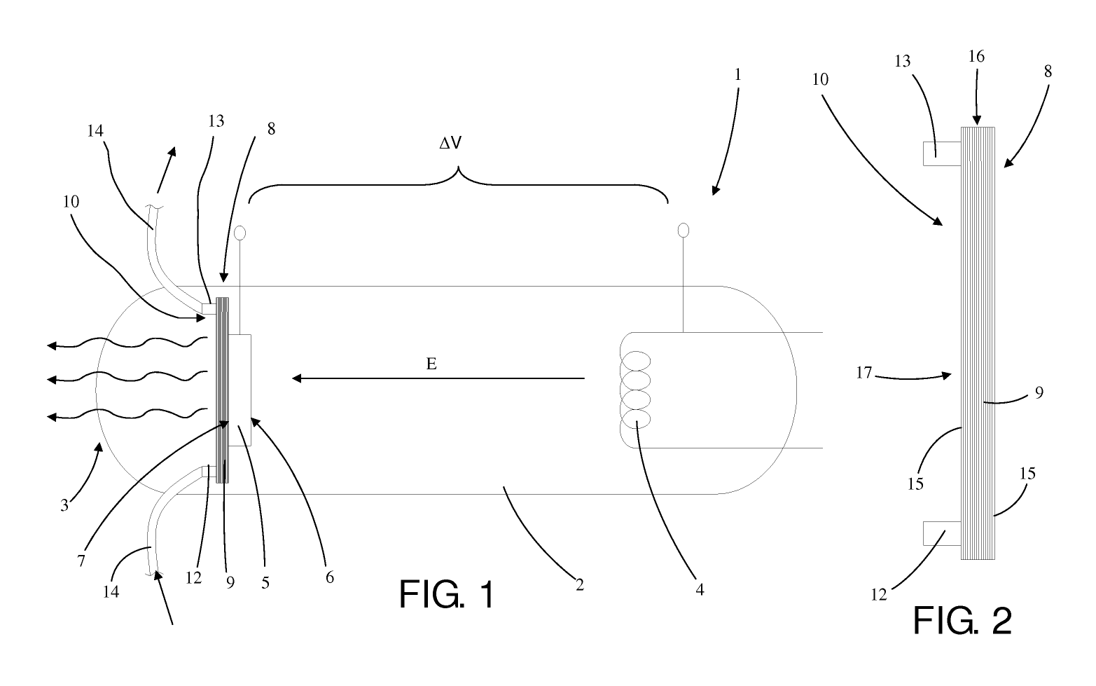

FIG. 1 is a schematic view of an X-ray tube made in accordance with this invention;

FIG. 2 is an enlarged detail of the tube of FIG. 1;

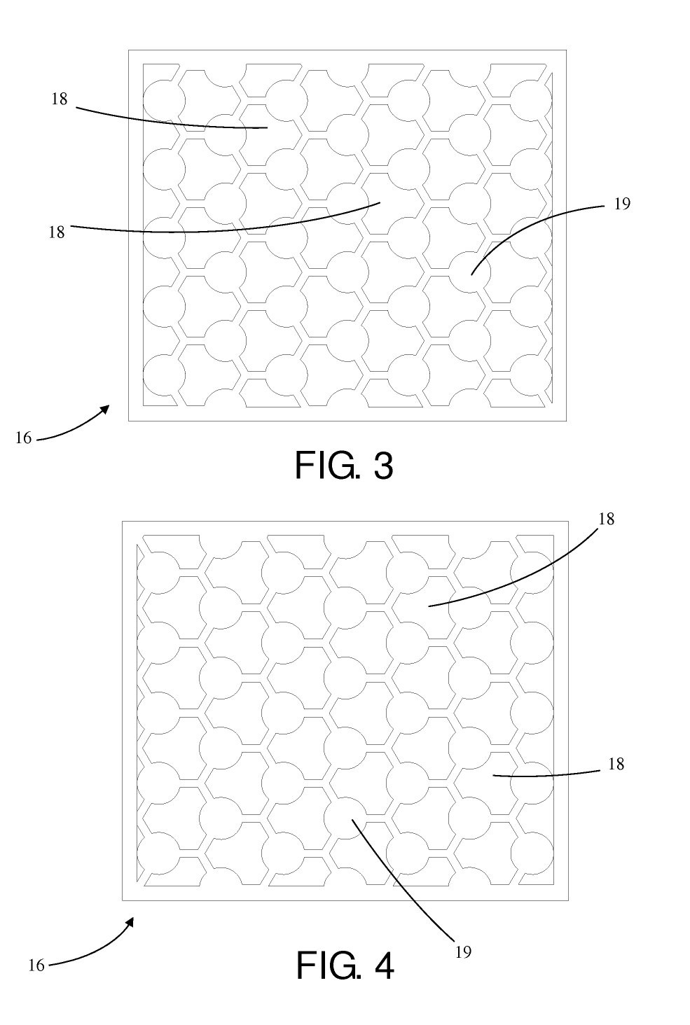

FIG. 3 is a schematic top view of a plate which is part of a component part of the X-ray tube of FIG. 1;

FIG. 4 is a schematic top view of another plate;

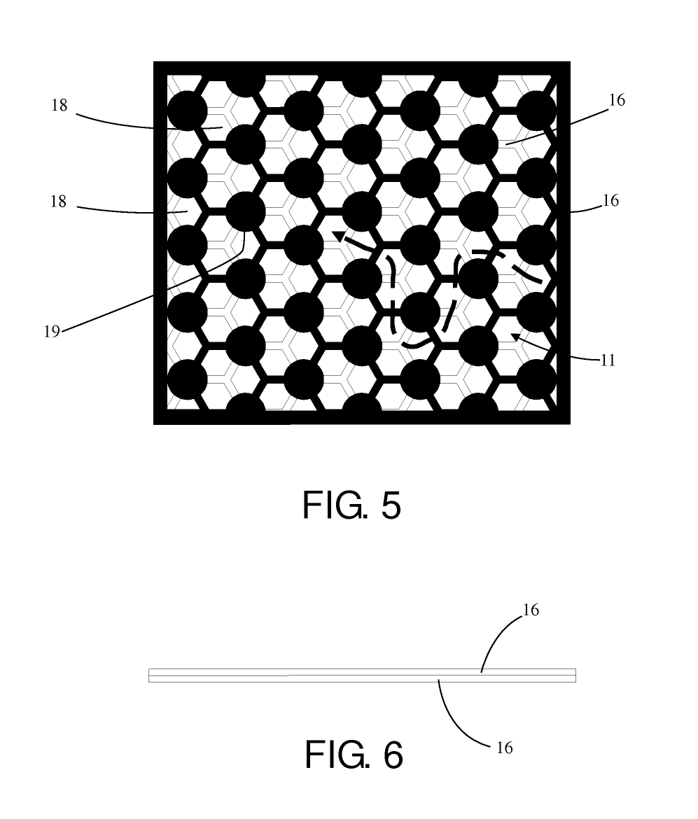

FIG. 5 is a top view of the plates of FIGS. 3 and 4 in which the plates are coupled together; and

FIG. 6 is a schematic front view of the plates of FIG. 5.

With reference to the accompanying drawings the numeral 1 denotes as a whole an X-ray tube made in accordance with this invention.

Similarly to prior art X-ray tubes, the X-ray tube according to this invention comprises first a containment element 2 which is advantageously a glass bulb or the like. The containment element 2 also comprises an emission section 3, through which the X-rays produced in the tube 1 can be sent towards the zone where they are used (for example, for X-ray examination of a piece of timber). As shown in FIG. 1, a cathode 4 and an anode 5 separated by a space are mounted inside the containment element 2.

The cathode 4 may be made in the same way as the prior art cathodes. In FIG. 1, in particular, it is a heated coil able to emit electrons E due to a thermionic effect.

In contrast, the anode 5, like the prior art anodes, in this invention is made of material able to emit X-rays if struck by electrons E which have predetermined kinetic energy. The anode 5 comprises a first main face 6 which is substantially facing towards the cathode 4 and a second main face 7 which is facing the opposite way to the first face 6.

According to this invention, the first main face 6 of the anode 5 does not need to be angled relative to the plane perpendicular to the direction extending from the cathode 4 towards the anode 5. As is described in more detail below, according to this invention, the X-rays used from the X-ray tube 1 are not the backward rays as in the case of prior art tubes, but the forward rays, that is to say, the rays which, in practice, exit the second main face 7 of the anode 5.

Advantageously, cooling means 8 are applied to the second main face 7 of the anode 5 to dissipate the heat generated during the production of the X-rays. The cooling means 8 preferably comprise a heat conductor element 9 which is thermally coupled with the second main face 7 of the anode 5, and inside which a coolant fluid such as water flows.

The main aspect of this invention is the fact that the cooling means 8 perform a dual function. They are also filter means 10 able to filter, based on the respective wavelengths, the X-rays emitted by the anode 5 (in FIG. 1 the X-rays are represented by undulating arrows).

Thanks to that innovative embodiment, in accordance with this invention the emission section 3 for the X-rays, through which the rays exit the containment element 2, is positioned in such a way that, in practice, it receives the X-rays emitted from the second main face 7 of the anode 5, that is to say, the forward rays, after they have passed through the filter means 10.

In the preferred embodiment this is achieved by making the heat conductor element 9 in such a way that it houses a plurality of micro-channels 11 in which, in practice, a pressurised coolant liquid can flow with turbulent motion. Within the scope of this invention, the term micro-channels 11 refers to channels having at least one dimension which is not greater than several tenths of a millimetre.

In the ideal embodiment, the heat conductor element 9 therefore has a “porous” structure in which the set of the various pores, which are all in fluid communication with each other, forms the set of micro-channels 11. In this way, on one hand a very large heat exchange surface area is obtained, and on the other hand a turbulent motion of the coolant fluid in the micro-channels 11 is generated. Both of these factors help to maximise heat removal by the coolant fluid.

Moreover, to allow circulation of the fluid, the heat conductor element 9 comprises at least one inlet section 12 and at least one outlet section 13 for the coolant fluid which are in fluid communication with the micro-channels 11 (in the embodiment illustrated the inlet section 12 and the outlet section 13 are two pipe fittings). In more complete embodiments of this invention, the X-ray tube 1 is therefore also equipped with means for feeding a pressurised coolant fluid to the cooling means 8 (such as a pump—not illustrated—and suitable pipes 14).

In the preferred embodiment, the heat conductor element 9 advantageously comprises a plurality of flat plates 15, 16 packed one on top of another to form a lamellar pack 17 extending mainly flat. Moreover, the lamellar pack 17 preferably extends mainly parallel with the plates (FIG. 2).

In the lamellar pack 17 two end plates 15 can be identified (to which the inlet section 12 and the outlet section 13 are connected) which are substantially without holes (with the exception of those for connecting the inlet section 12 and the outlet section 13 for the coolant fluid), as well as a plurality of inner plates 16.

As shown in FIGS. 3 and 4, each inner plate 16 of the lamellar pack 17 comprises a plurality of through holes 18 which are distributed on its surface. For that purpose, advantageously each inner plate 16 has the shape of a grille with regular meshes. In the embodiment illustrated each hole 18 has a three-lobed shape formed by a hexagonal mesh with three circular areas 19 at alternate vertices of the hexagon.

To form the micro-channels 11, once the pack has been made, the holes 18 in each plate are only partly aligned with the holes 18 of the plates immediately adjacent to it. In particular if the shape and size of the meshes is the same for all of the plates, in the lamellar pack 17 the meshes of each plate are offset relative to the meshes of the plates opposite it.

Moreover, advantageously, each hole 18 in each of the inner plates 16 of the lamellar pack 17 is partly opposite at least two different holes 18 of each inner plate 16 directly facing it, thus putting them in fluid communication with each other.

That situation is schematically illustrated in FIGS. 5 and 6 which show the plates of FIGS. 3 and 4 coupled one on top of another. Solely to make the drawing easier to understand, in FIG. 5 the plate of FIG. 3 is positioned on top and is completely black, whilst the plate of FIG. 4 is on the bottom. Moreover, in FIG. 5 the arrow drawn with a dashed line indicates a possible path for the coolant fluid (when the arrow passes through a stretch of the black coloured plate, it means that the fluid flows into the hole 18 in the plate below).

Moreover, in the preferred embodiment, the lamellar pack 17 is obtained by alternating only two types of inner plates 16 (such as those of FIGS. 3 and 4). Advantageously, in the embodiment illustrated all of the plates have the same shape: that of FIG. 4 is none other than the same plate as in FIG. 3 but turned over. The plates 16 are also sized in such a way that the circular parts 19 of the meshes of one plate are precisely superposed on those of the adjacent meshes.

Moreover, to obtain a correct filtering effect on the X-rays, the heat conductor element 9 is advantageously made of a material known for such properties, such as copper or beryllium or another metal. Advantageously, in the preferred embodiments the thickness of the lamellar pack 17 is less than 1 cm whilst the thickness of each plate 15, 16 is several tenths of a millimetre or even less.

As already indicated, the embodiment of this invention described above is one of the most simple embodiments possible. However, with the appropriate adjustments, this invention may also advantageously be applied with more complex embodiments, such as embodiments equipped with means for centring and focusing the electron flow and the X-rays, or embodiments with a rotating anode (in this case, obviously, a suitable embodiment of the inlet section 12 and the outlet section 13 will be required).

Operation of the X-ray tube 1 according to this invention is substantially like that of conventional tubes as regards the generation of X-rays. The cathode 4 emits electrons E which are accelerated by the difference in potential ΔV applied between the cathode 4 and the anode 5, reaching a predetermined speed and thus acquiring a predetermined kinetic energy, a small part of which is converted into X-rays at the moment when the electrons E strike the anode 5.

The forward rays generated pass through the heat conductor element 9 which eliminates the unwanted wavelengths, whilst the useful ones are able to reach the emission section 3 unhindered. At the same time, the coolant fluid is circulated under pressure in the micro-channels 11, guaranteeing suitable cooling of the anode 5 which is thermally coupled with the heat conductor element 9. This invention brings important advantages.

Thanks to this invention it was possible to provide an X-ray tube which, the absorbed power being equal, guarantees available output in terms of X-rays that is significantly higher, that is to say, tubes which are considerably more efficient.

Alternatively, the available output being equal, this invention allows the production of X-ray tubes which are much less expensive than conventional tubes.

Finally, it should be noticed that this invention is relatively easy to produce and that even the cost linked to implementing the invention is not very high.

The invention described above may be modified and adapted in several ways without thereby departing from the scope of the inventive concept.

Moreover, all details of the invention may be substituted with other technically equivalent elements and the materials used, as well as the shapes and dimensions of the various components, may vary according to requirements.

1. An X-ray tube comprising:
a containment element (2) comprising an X-ray emission section (3);
a cathode (4) mounted in the containment element (2);
an anode (5) mounted in the containment element (2), distanced from the cathode (4) and made of material able to emit X-rays if struck by electrons (E) which have a predetermined kinetic energy, the anode (5) comprising a first main face (6) which is substantially facing towards the cathode (4) and a second main face (7) which is facing the opposite way to the first face (6);
cooling means (8) applied to the second main face (7) of the anode (5); and
filter means (10) for filtering, based on respective wavelengths, the X-rays emitted by the anode (5),
and consisting of the cooling means (8);
the X-ray emission section (3) being positioned in such a way that, in practice, it receives the X-rays emitted by the second main face (7) of the anode (5) after they have passed through the filter means (10);
the cooling means (8) and the filter means (10) consisting of a heat conductor element (9) which is thermally coupled with the second face (7) of the anode (5) and which is equipped with a plurality of inner micro-channels (11) in which, in practice, a pressurised coolant liquid can flow with a turbulent motion,
characterised in that the heat conductor element (9) comprises a plurality of flat plates packed one on top of another to form a lamellar pack (17) extending mainly flat, each inner plate (16) of the lamellar pack (3) comprising a plurality of through-holes (18) distributed over its surface, the holes (18) of each plate being only partly aligned with the holes (18) of the immediately adjacent plates, the set of holes (18) of the various plates forming said plurality of micro-channels (11).

2-3. (canceled)

4. The X-ray tube according to claim 1, characterised in that each hole (18) in each of the inner plates (16) of the lamellar pack (17) is partly opposite at least two different holes (18) of each inner plate (16) directly facing it, thus putting them in fluid communication with each other.

5. The X-ray tube according to claim 1, characterised in that the inner plates (16) of the lamellar pack (17) have a grille shape with regular meshes, the meshes of each plate being offset relative to the meshes of the plates opposite it.

6. The X-ray tube according to claim 1, characterised in that the lamellar pack (17) is less than 1 cm thick and each plate is around several tenths of a millimetre thick.

7. The X-ray tube according to claim 1, characterised in that the heat conductor element (9) is made of metal.

8. The X-ray tube according to claim 1, characterised in that the heat conductor element (9) also comprises at least one inlet section (12) and at least one outlet section (13) for the coolant fluid, said sections being in communication with the micro-channels (11).

9. The X-ray tube according to claim 1, characterised in that it also comprises means for feeding a pressurised coolant fluid to the cooling means (8).

10. The X-ray tube according to claim 4, characterised in that the inner plates (16) of the lamellar pack (17) have a grille shape with regular meshes, the meshes of each plate being offset relative to the meshes of the plates opposite it.

11. The X-ray tube according to claim 4, characterised in that the lamellar pack (17) is less than 1 cm thick and each plate is around several tenths of a millimetre thick.

12. The X-ray tube according to claim 5, characterised in that the lamellar pack (17) is less than 1 cm thick and each plate is around several tenths of a millimetre thick.

13. The X-ray tube according to claim 4, characterised in that the heat conductor element (9) is made of metal.

14. The X-ray tube according to claim 5, characterised in that the heat conductor element (9) is made of metal.

15. The X-ray tube according to claim 4, characterised in that the heat conductor element (9) also comprises at least one inlet section (12) and at least one outlet section (13) for the coolant fluid, said sections being in communication with the micro-channels (11).

16. The X-ray tube according to claim 5, characterised in that the heat conductor element (9) also comprises at least one inlet section (12) and at least one outlet section (13) for the coolant fluid, said sections being in communication with the micro-channels (11).

17. The X-ray tube according to claim 4, characterised in that it also comprises means for feeding a pressurised coolant fluid to the cooling means (8).

18. The X-ray tube according to claim 5, characterised in that it also comprises means for feeding a pressurised coolant fluid to the cooling means (8).

19. The X-ray tube according to claim 8, characterised in that it also comprises means for feeding a pressurised coolant fluid to the cooling means (8).

20. The X-ray tube according to claim 15, characterised in that it also comprises means for feeding a pressurised coolant fluid to the cooling means (8).

21. The X-ray tube according to claim 16, characterised in that it also comprises means for feeding a pressurised coolant fluid to the cooling means (8).
